(19) United States
(12) Patent Application Publication
(10) Pub. No.: US 2011/0229183 A1
(43) Pub. Date: Sep. 22, 2011

(54) IMAGE PROCESSING DEVICE FOR PROCESSING JOBS TO BE EXECUTED BY IMAGE FORMING DEVICE INCLUDING FIXING UNIT

(75) Inventors: Hirotada SEKI, Toyokawa-shi (JP); Yoshiki KATAYAMA, Toyokawa-shi (JP); Satoru SASAKI, Toyokawa-shi (JP); Natsuyo HIGASHI, Toyokawa-shi (JP); Hiroaki TAKATSU, Nishio-shi (JP)

(73) Assignee: Konica Minolta Business Technologies, Inc., Chiyoda-ku (JP)

(21) Appl. No.: 13/040,061

(22) Filed: Mar. 3, 2011

(30) Foreign Application Priority Data
Mar. 17, 2010 (JP) 2010-060581

(51) Int. Cl. G03G 15/00

(52) U.S. Cl. 399/82; 399/85

(57) ABSTRACT

An image processing device processes jobs to be executed by an image forming device incorporating a fixing unit. The image processing device receives a plurality of jobs. Based on an attribute of each of the plurality of jobs, the image processing device determines, out of the plurality of jobs, at least one job for which fixing can be performed after heating of the fixing unit is stopped and for which fixing is performed after fixing for another job is finished. The image processing device reorders the processing of the plurality of jobs so that fixing is performed for the at least one job after the fixing for the other job is finished. In this way, an image processing device and a method of controlling an image processing device can be provided where power consumption can be reduced.

This application is based on Japanese Patent Application No. 2010-060581 filed with the Japan Patent Office on Mar. 17, 2010, the entire content of which is hereby incorporated by reference.

### BACKGROUND OF THE INVENTION

1. Field of the Invention

The present invention relates to an image processing device and a method of controlling an image processing device, and more particularly, to an image processing device and a method of controlling an image processing device for processing jobs to be executed by an image forming device such as a copier or a printer.

2. Description of the Related Art

Electrophotographic image forming devices include multi-function peripherals (MFPs) featuring scanning functions, facsimile functions, copying functions, printing functions, data communication functions and server functions, as well as facsimile devices, copiers, printers, and the like.

Generally, an image forming device forms an image on paper by: forming a toner image on an image carrier using a developer roller, transferring on paper (i.e. a transfer material) the toner image formed on the image carrier, and fixing the toner image on the paper using a fixing device.

An image forming device receives an instruction from a user to print manuscript data, and prints that manuscript data. An instruction is an operational unit for printing and is called a “job” or a “print job”. Techniques have been developed to make the overall printing process for all the jobs more effective when several jobs are provided to an image forming device and thus a number of jobs are accumulated in the image forming device.

Document 1, specified below, for example, discloses an image forming device which, after receiving a series of jobs, stores into memory print data for each of the jobs and information specifying image forming conditions. Then, a printing order is designated where jobs with lower fixing temperatures are earlier and jobs with higher fixing temperatures are later. Thereafter, the printing operation is initiated and follows the designated printing order.

Document 2, specified below, discloses an image forming device which, when a power-saving printing mode is set, changes the order of image information sets based on attributes, such as image color, paper thickness, paper size and image area proportion, predetermined as factors that affect power consumption. Motors and the like for the image processing system and the paper transport system are controlled in accordance with changes in the order of the image information sets.

Document 3, specified below, discloses an image forming device that calculates the proportion of the image area in each of a plurality of pages based on image data and detects the internal temperature in a light emitting diode (LED) print head (LPH) using an internal temperature sensor. If the internal temperature is higher than a first reference temperature, the order of pages in image forming is changed based on such proportions of image area. If the internal temperature is equal to or lower than the first reference temperature, the order of pages in image forming remains unchanged and images are formed in the order of pages.
[Document 1] Japanese Patent Application Laid-Open No. 2004-333989
[Document 2] Japanese Patent Application Laid-Open No. 2008-273141
[Document 3] Japanese Patent Application Laid-Open No. 2005-221766

The fixing device in an image forming device fixes a toner image on transfer material by applying heat and pressure to the transfer paper having the transferred toner image on it. Thus, a significant amount of heat remains in the fixing device immediately after all the jobs are processed; the heat is not used for any purposes at all. This leaves power consumption at a relatively high level. This problem is observed in any kind of image forming device including a fixing unit.

### SUMMARY OF THE INVENTION

The object of the present invention is to provide an image processing device and a method of controlling an image processing device where power consumption can be reduced.

An image processing device according to an aspect of the present invention is an image processing device for processing jobs to be executed by an image forming device including a fixing unit, including: a receiving unit that receives a plurality of jobs; a determining unit that, based on an attribute of each of the plurality of jobs, determines, out of the plurality of jobs, at least one job for which fixing can be performed after heating of the fixing unit is stopped and for which fixing is performed after fixing for another job is finished; and a reordering unit that reorders processing of the plurality of jobs so that the fixing for the at least one job determined by the determining unit is performed after the fixing for the other job is finished and after the heating of the fixing unit is stopped.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a side view showing a configuration of an image forming device according to a first embodiment of the present invention.

FIG. 2 is a block diagram showing a control configuration of the image forming device according to the first embodiment of the present invention.

FIG. 3 illustrates an example of a change in the fixing order of jobs 1-5.

FIG. 4 is a flow chart illustrating a process for reordering the fixing for jobs performed by the control unit of the image forming device according to the first embodiment of the present invention.

FIG. 5 schematically shows temperature changes in the fixing device in an image forming device of the example for comparison.

FIG. 6 schematically shows temperature changes in the fixing device in the image forming device according to the first embodiment of the present invention.

FIG. 7 illustrates another example of a change in the fixing order of jobs 1-5.

FIG. 8 is a flow chart illustrating a process for reordering the fixing for jobs performed by a control unit of an image forming device according to the second embodiment of the present invention.

FIG. 9 illustrates an attribute of jobs 1-5.

FIG. 10 is a flow chart illustrating a process for reordering the fixing for jobs performed by a control unit of an image forming device according to the third embodiment of the present invention.

FIG. 11 illustrates a fixing order of a plurality of unprinted jobs.

FIG. 12 is a flow chart illustrating a process for reordering the fixing for jobs performed by a control unit of an image forming device according to the fourth embodiment of the present invention.

FIG. 13 is a flow chart illustrating a process for controlling a heater performed by the control unit of the image forming device according to the fourth embodiment of the present invention.

FIG. 14 shows an entire configuration of an image forming device system according to a fifth embodiment of the present invention.

### DESCRIPTION OF THE PREFERRED EMBODIMENTS

Embodiments of the present invention will now be described with reference to drawings.

### First Embodiment

The present embodiment explains a configuration of an image forming device incorporating an image processing device as well as a process performed by this image processing device.

### [Configuration of Image Forming Device]

First, the configuration of the image forming device according to the present embodiment will be described.

Referring to FIG. 1, an image forming device 1 includes a paper cassette 3, a catch tray 5, an image forming unit 30 and a control unit 40. Control unit 40 is an example of an image processing unit of the present invention and is incorporated in image forming device 1.

Paper cassette 3 is disposed below image forming device 1 and is removable from the housing of image forming device 1. During printing, a sheet (i.e. a recording medium) loaded into a paper cassette 3 is fed into the device from paper cassette 3, one by one, and is moved to image forming unit 30.

Catch tray 5 is disposed on top of the housing of image forming device 1. A sheet on which an image has been formed by image forming unit 30 is discharged from inside the housing to catch tray 5.

Image forming unit 30 is disposed within the housing of image forming device 1. Image forming unit 30 generally includes a paper transport unit 200, a toner image forming unit 300, and a fixing device 400. Image forming unit 30 combines images in four different colors, i.e. yellow (Y), magenta (M), cyan (C) and black (K) as required, using the so-called tandem method, thereby forming a color image on a sheet.

Paper transport unit 200 is composed of a feed roller 210, a transport roller 220, a discharge roller 230 and other components. Transport roller 220 and discharge roller 230 each transports a sheet, where two opposite rollers, for example, that sandwich the sheet are rotated.

Feed roller 210 feeds one sheet at a time from paper cassette 3. The sheet is fed into the interior of the housing of image forming device 1 by feed roller 210. Transport roller 220 transports the sheet fed by feed roller 210 to toner image forming unit 300. Transport roller 220 transports the sheet that has passed fixing device 400 to discharge roller 230. Discharge roller 230 discharges the sheet that has been transported by transport roller 220 to the outside of the housing of image forming device 1.

Paper transport unit 200 may also include other rollers used to transport a sheet or for other purposes.

Toner image forming unit 300 is composed of four toner bottles (examples of supply mechanisms) 301Y, 301M, 301C and 301K for different colors (also referred to as toner bottles 301), an intermediate transfer belt 305, a transfer roller 307, four print units 310Y, 310M, 310C and 310K (also referred to as print units 310), a laser scanning unit 320, and other components.

Yellow toner bottle 301Y, magenta toner bottle 301M, cyan toner bottle 301C and black toner bottle 301K store Y, M, C and K toners, respectively. Toner bottles 301Y, 301M, 301C and 301 K are driven for rotation by drive motors 330Y, 330M, 330C and 330K (also referred to as drive motors 330), respectively, and supply their respective print units 310 with toner stored within. Supplying of toner is performed when developing device 350 of print unit 310 runs short of toner, as described below.

Intermediate transfer belt 305 forms a loop and is laid around two rollers (not shown). Intermediate transfer belt 305 is rotated in a synchronized manner with paper transport unit 200. Transfer roller 307 is positioned facing the portion of intermediate transfer belt 305 that is in contact with one of the rollers. The distance between transfer roller 307 and intermediate transfer belt 305 is regulated by a pressing/separating mechanism. A sheet is sandwiched and transported by intermediate transfer belt 305 and transfer roller 307.

A print unit 310 includes a photoreceptor drum 311, developing device 350, a cleaner, an electrifying device, and other components, where photoreceptor drum 311 is represented by photoreceptor drums 311Y, 311M, 311C and 311K corresponding to print units 310Y, 310M, 310C and 310K, respectively; developing device 350 is represented by developing devices 350Y, 350M, 350C an 350K corresponding to photoreceptor drums 311Y, 311M, 311C and 311K, respectively. Yellow print unit 310Y, magenta print unit 310M, cyan print unit 310C and black print unit 310K are arranged so as to form Y, M, C and K images, respectively. Print units 310 are arranged side by side directly below intermediate transfer belt 305. Laser scanning unit 320 is located so that it can scan photoreceptor drums 311 with a laser beam.

In toner image forming unit 300, laser scanning unit 320 forms a latent image on photoreceptor drums 311, which have been electrified in a unified manner by the electrifying device, based on image data for colors Y, M, C and K. Development device 350 forms toner images on photoreceptor drums 311 by causing toner in different colors to adhere to photoreceptor drums 311 having the latent image on it (“development”). Photoreceptor drums 311 transfer the toner images onto intermediate transfer belt 305 to form, on intermediate transfer belt 305, a minor image of the toner image in the four colors that is to be formed on the sheet (“primary transfer”). Then, transfer roller 307, to which a high voltage has been applied, transfers the toner image formed on intermediate transfer belt 305 onto the sheet, thereby forming a toner image on the sheet (“secondary transfer”).

A fixing device 400 includes a heating roller 401, a pressure roller 403, a heater 405 and a fan 407. Heater 405 is incorporated in pressure roller 401. Applying a voltage to heater 405 causes heater 405 to become hot, thereby heating heating roller 401. Heat caused by heater 405 is discharged by fan 407 to outside image forming device 1. Fixing device 400 transports a sheet, on which a toner image is formed, by means of heating roller 401 and pressure roller 403 that work together to sandwich the sheet, and heats and presses it. In this way, fixing device 400 melts the toner adhering to the sheet and fixes it onto the sheet, thereby forming an image on the sheet. The sheet that has passed fixing device 400 is discharged by discharge roller 230 from the housing of image forming device 1 onto catch tray 5. Although the present embodiment shows a fixing device 400 with two rollers, fixing device 400 may use a roller and a belt.

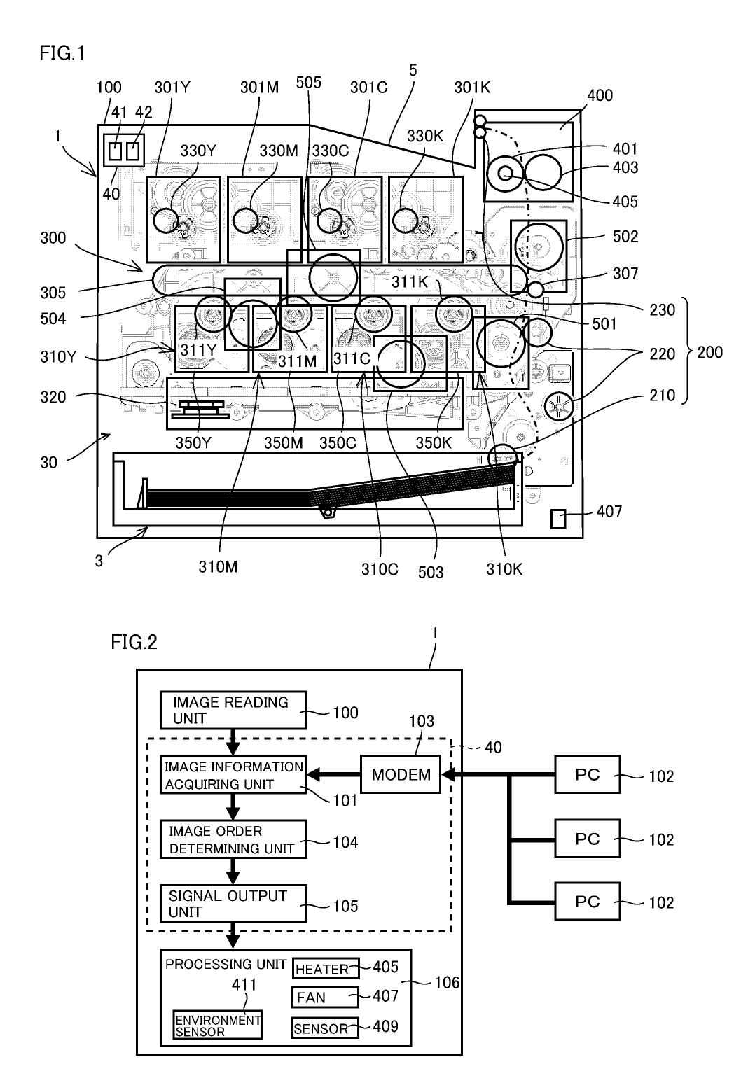

At the time of the fixing, the temperature in fixing device 400 is controlled such that the device has a temperature required for the fixing. The temperature required for fixing depends on an attribute of a job (for example, image color, paper type (such as thickness or material), paper size, image area proportion and the like). The temperature in fixing device 400 is controlled by adjusting the output of voltage applied to heater 405 (for example, turning the voltage on/off). Specifically, the temperature may be controlled by measuring the temperature in fixing device 400 (or the surface temperature of heating roller 401 or the like) using sensor 409 (FIG. 2) and, if it is lower than a target temperature, applying a voltage to heater 405 or, if it is higher, stopping such application.

Image forming unit 30 includes, for example, a main motor 501, a fixing motor 502, a black development motor 503, a color development motor 504, and a color photoreceptor motor 505 (also referred to as motors 501-505). Main motor 501 transports paper beginning at the feed step and ending at the transfer step, and drives intermediate transfer belt 305 and black photoreceptor drum 311K. Fixing motor 502 drives fixing device 400. Black development motor 503 drives black print unit 301K including black developing device 350K. Color development motor 504 drives print units 310Y, 310M and 310C including yellow, magenta and cyan developing devices 350. Color photoreceptor motor 505 drives yellow, magenta and cyan photoreceptor drums 311Y, 311M and 311C. Other than these motors 501-505, a pressing/separating motor may be provided for adjusting the pressure with which to sandwich paper at transfer roller 307 or fixing device 400, for example.

Control unit 40 includes, for example, a central processing unit (CPU) 41 and a storage unit 42. CPU 41 is a controller for controlling the entire set of operations in the image forming device. Storage unit 42 stores, for example, a control program for controlling image forming operations and a program used for calculating the quantity of residual heat existing in fixing device 400 after the stop of heating and the quantity of heat required for fixing for a job, for example.

Image forming device 1 may further include an image reading unit 100 for reading an image from a manuscript.

FIG. 2 is a block diagram showing a control configuration of the image forming device according to the first embodiment of the present invention.

Referring to FIG. 2, image forming device 1 includes an image reading unit 100, an image information acquiring unit 101, a modem 103, an image order determining unit 104, a signal output unit 105, and a processing unit 106. Modem 103, image order determining unit 104 and signal output unit 105 constitute part of control unit 40.

Image reading unit 100 uses a charge-coupled device (CCD) sensor or the like to read an image of a manuscript placed on the glass. Image information acquiring unit 101 is connected to a plurality of PCs 102 used by a user via modem 103, for example, and acquires (i.e. receives) manuscript image information sent by image reading unit 100, or image information (print information) related to a job sent by PCs 102, via modem 103. Image order determining unit 104 estimates a required quantity of heat based on an attribute of the job obtained from the image information acquired at image information acquiring unit 101, and compares it with the residual heat in fixing device 400 existing after the stop of application of voltage to heater 405. Thereafter, it changes the order of reception of the plurality of jobs to the order of fixing for the jobs (i.e. reorders the jobs). Signal output unit 105 outputs a signal to various parts of processing unit 106 and the like to perform printing in the order of jobs determined by image order determining unit 104. Processing unit 106 comprises heater 405, fan 407, sensor 409, an environment sensor 111, an image processing system, a fixing processing system, a paper transport system, and the like.

Out of the plurality of jobs for image forming device 1, control unit 40 determines at least one job for which fixing can be performed after heating of fixing device 400 is stopped (i.e. after the stop of heating) and for which fixing is performed after fixing for another job is finished. Then, control unit 40 changes the order of the jobs to be processed so that the fixing for the at least one job determined is performed after the fixing for the other job is finished and after the heating of the fixing unit is stopped. Hereinafter, at least one job for which fixing can be performed after the stop of heating of fixing device 400 and for which fixing is performed after the fixing for another job is finished will also be referred to as a “post-heating job”.

### [Method for Determining Order of Fixing]

Next, how the control unit of the image forming device of the present embodiment determines an order of fixing will be described. The present embodiment estimates the quantity of heat required for fixing for each of a plurality of jobs (also referred to as the required quantity of heat) based on an attribute of each of the plurality of jobs acquired at image information acquiring unit 101. It also estimates the quantity of residual heat in fixing device 400 after the stop of heating based on an attribute of the job for which fixing was performed directly before the stop of heating of fixing device 400. In addition, it determines a post-heating job based on the required quantity of heat and the quantity of residual heat to determine the order of fixing.

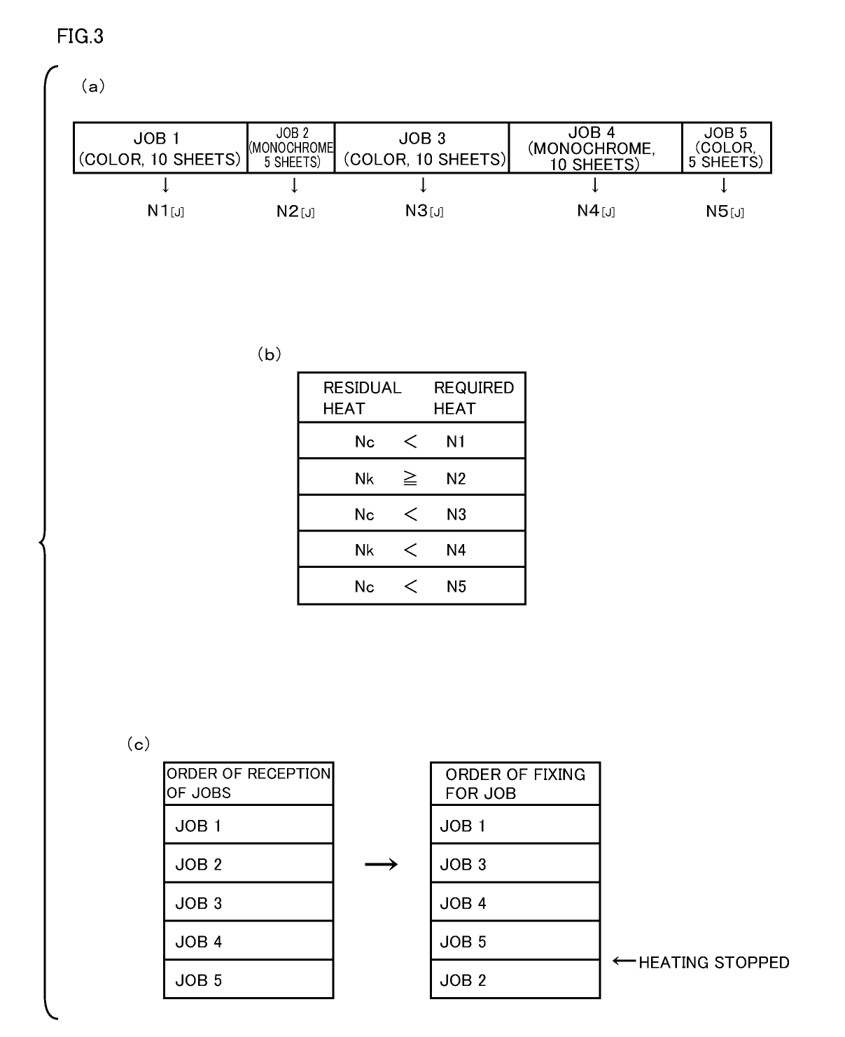

FIG. 3 illustrates an example of a change in the fixing order of jobs 1-5. (a) illustrates an attribute of jobs 1-5 and required quantities of heat; (b) illustrates an example of a set of comparisons between the required quantities of heat and the quantities of residual heat for jobs 1-5 in (a); and (c) illustrates an example of a fixing order of jobs 1-5 in (a).

Referring to FIG. 3 (a), it is assumed that CPU 41 receives jobs 1-5 in this order from image reading unit 100 or a PC 102. Job 1 includes ten color prints; job 2 includes five monochrome prints; job 3 includes ten color prints; job 4 includes ten monochrome prints; and job 5 includes five color prints. All of jobs 1-5 have the same attributes except image color (color/monochrome) and number of sheets to be printed.

CPU 41 of control unit 40 estimates quantities of heat N1-N5 required for fixing for jobs 1-5, respectively (required quantities of heat), based on the image color (color or monochrome) for received jobs 1-5 and the number of sheets to be printed.

The required quantity of heat depends on an attribute of the job (for example, image color, paper type, paper size, image area proportion or the like). For example, to perform the fixing for a color print, fixing device 400 must be kept at or above a color target temperature. The quantity of heat required to keep fixing device 400 at the color target temperature during the fixing for a color print job is the required quantity of heat for the color print job. Similarly, to perform the fixing for a monochrome print, fixing device 400 must be kept at or above a monochrome target temperature; the quantity of heat required to keep fixing device 400 at the monochrome target temperature during the fixing for a monochrome print job is the required quantity of heat for the monochrome print.

Other than image color and number of sheets to be printed, or in addition to image color and number of sheets to be printed, the required quantity of heat may also depend on, for example, paper type, paper size, image area proportion or the like.

To facilitate the estimation of the required quantity of heat, data including a correlation between a job attribute and the estimated required quantity of heat, for example, may be stored beforehand in storage unit 42. In this case, CPU 41 may access storage unit 42 to extract from that data the required quantity of heat related to the job attribute in order to estimate the required quantity of heat.

Further, CPU 41 estimates the quantity of residual heat in fixing device 400 after the stop of heating. The quantity of residual heat is the quantity of heat remaining in fixing device 400 after the stop of application of voltage to the heater incorporated in fixing device 400, for example, and depends on an attribute of a job for which fixing is performed directly before the stop of heating of fixing device 400. In the present embodiment, the heating of fixing device 400 is stopped after the fixing for the last received job (i.e. job 5), and thus the quantity of residual heat in fixing device 400 depends on the image color for job 5 or the number of sheets to be printed for job 5.

To facilitate the estimation of the quantity of residual heat, data including a correlation between a job attribute and the estimated quantity of residual heat, for example, may be stored beforehand in storage unit 42. In this case, CPU 41 may access storage unit 42 to extract from that data the quantity of residual heat related to an attribute of a job for which fixing is performed directly before the stop of heating of fixing device 400 in order to estimate the quantity of residual heat.

If storage unit 42 stores correlation data as described above, data stored in storage unit 42 may be the quantity of residual heat, which is a fixed number, estimated separately for a monochrome print and a color print. Alternatively, data stored in storage unit 42 may include the estimated quantity of residual heat, which increases stepwise as the number of sheets to be printed for a given job increases.

It suffices if the quantity of residual heat is estimated based on an attribute of a job directly before the stop of heating. Other than image color (i.e. monochrome print or color print) and number of sheets to be printed, or in addition to image color and number of sheets to be printed, the quantity of residual heat may depend on paper type, paper size, image area proportion or the like. Further, when the quantity of residual heat is to be estimated, effects of temperatures measured by sensor 409 or temperatures around (and/or inside) the image forming device measured by environment sensor 411 (FIG. 2) may be taken into consideration.

Preferably, the estimated quantity of residual heat may be provided as, for example, a color print-enabling quantity of heat Nc and a monochrome print-enabling quantity of heat Nk. Color print-enabling quantity of heat Nc is a quantity of heat that can be used for color printing. Monochrome print-enabling quantity of heat Nk is a quantity of heat that can be used for monochrome printing.

Next, CPU 41 determines a job for which a toner image is fixed after the stop of heating of fixing device 400 (i.e. a post-heating job) based on quantities of heat N1-N5 and the estimated quantity of residual heat. For example, quantities of heat N1, N3 and N5 for jobs 1, 3 and 5, respectively, which are color print jobs are compared with color print-enabling quantity of heat Nc, and quantities of heat N2 and N4 for jobs 2 and 4, respectively, which are monochrome print jobs, are compared with monochrome print-enabling quantity of heat Nk. Following this, CPU 41 designates as a post-heating job a job with its required quantity of heat equal to or lower than color print-enabling quantity of heat Nc or equal to or lower than monochrome print-enabling quantity of heat Nk.

Instead of determining a post-heating job in the manner described above, CPU 41 may determine a post-heating job depending on whether a required quantity of heat is smaller than color print-enabling quantity of heat Nc or monochrome print-enabling quantity of heat Nk.

In FIG. 3 (b), quantity of heat N1 for job 1, quantity of heat N3 for job 3 and quantity of heat N5 for job 5 are larger than color print-enabling quantity of heat Nc; and quantity of heat N4 for job 4 is larger than monochrome print-enabling quantity of heat Nk. Conversely, quantity of heat N2 for job 2 is equal to or lower than monochrome print-enabling quantity of heat Nk. Accordingly, CPU 41 designates job 2 as a post-heating job.

As a result, as shown in FIG. 3 (c), the order of fixing for jobs is changed from the order of reception: job 1, job 2, job 3, job 4, and job 5 to the order: job 1, job 3, job 4, job 5, and job 2. Then, after the fixing for job 5 is finished, the heating of fixing device 400 is stopped and, using residual heat in fixing device 400 after the stop of heating, the fixing for job 2 is performed. In other words, if CPU 41 determines that job 2 can be printed using residual heat, it shifts job 2 to after job 5 and turns the heater off for fixing device 400 after job 5.

### [Flow Chart of Process for Reordering Fixing]

Next, a process will be described for reordering the fixing for jobs after the control unit of the image forming device of the present embodiment receives a plurality of jobs. The process shown in the following flow chart is implemented by CPU 41 (an example of a computer) of control unit 40 performing a program.

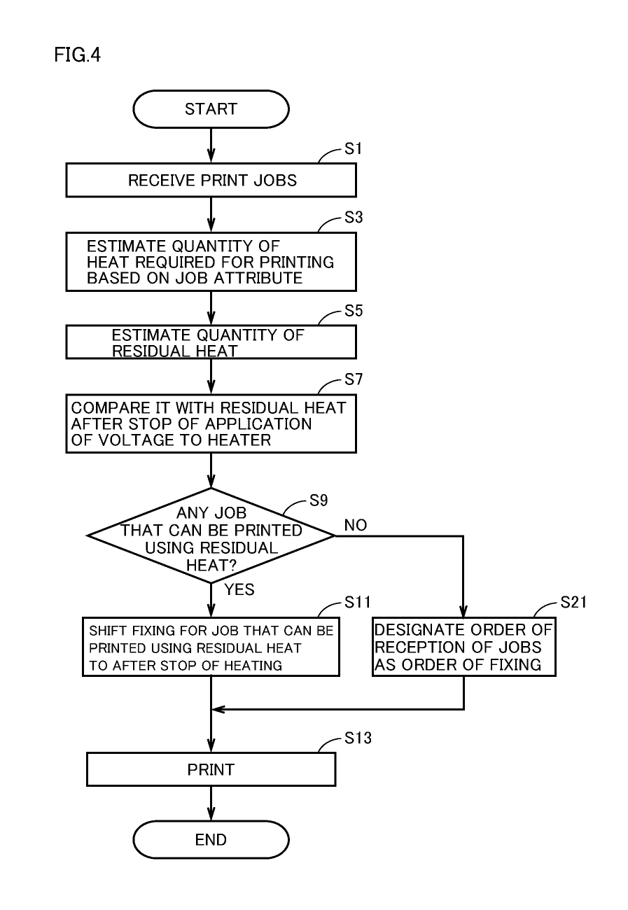

FIG. 4 is a flow chart illustrating a process for reordering the fixing for jobs performed by the control unit of the image forming device according to the first embodiment of the present invention.

Referring to FIG. 4, CPU 41 receives job input from image reading unit 100 or a PC 102 for a predetermined period of time, for example, to acquire image information about a plurality of jobs (S1). Each time CPU 41 receives a job, it estimates the quantity of heat required for the printing based on an attribute of the job (S3), and then estimates the quantity of residual heat existing in fixing device 400 after the stop of heating (i.e. after the application of voltage to heater 405 is stopped) (S5). Then, CPU 41 compares the required quantity of heat for each of the jobs with the estimated quantity of residual heat (S7). Next, CPU 41 determines if the jobs include one that can be printed using residual heat (that is, if there is a job with its required quantity of heat equal to or lower than the quantity of residual heat) (S9). If there is a job with its required quantity of heat equal to or lower than the quantity of residual heat, it is determined that there is a job that can be printed using residual heat (YES at S9). In this case, CPU 41 chooses this job as a post-heating job and reorders the fixing for jobs, starting from the order of reception of jobs, such that the fixing for the post-heating job can be performed after the stop of heating of fixing device 400 (S11). Fixing device 400 is then controlled such that the printing (i.e. fixing) is performed in the determined order of fixing (S13), and the process ends.

Conversely, if there is no job with its required quantity of heat equal to or lower than the quantity of residual heat, CPU 41 determines that there is no job that can be printed using residual heat (NO at S9). In this case, the fixing for jobs is not reordered and the order of reception of jobs is used as the order of fixing (S21). Fixing device 400 is then controlled such that the printing is performed in the determined order of fixing (S13), and the process ends. These steps perform the process for reordering the fixing.

### [Effects of Present Embodiment]

Effects of the present embodiment will now be described with the help of an example for comparison.

FIG. 5 schematically shows temperature changes in a fixing device in an image forming device of the example for comparison. The vertical axis shows the temperature and the horizontal axis shows the passing of time. The example for comparison shown in FIG. 5 assumes that, if jobs 1-5 sent from image reading unit 100 or a PC 102 are received in that order, the order of fixing is the order of reception and the fixing (output) is performed in the order of reception, i.e. job 1, job 2, job 3, job 4, and job 5. It also assumes that the color target temperature is higher than the monochrome target temperature.

Referring to FIG. 5, the temperature in fixing device 400 is kept at the color target temperature during the fixing for job 1, which is a color print job. The temperature in fixing device 400 is kept at or above the monochrome target temperature during the fixing for job 2, which is a monochrome print job. However, when the fixing for job 1 is finished, fixing device 400 has a temperature exceeding the monochrome target temperature, and thus the output of voltage applied to heater 405 incorporated in fixing device 400 is reduced (i.e. turned off, for example) during the fixing for job 2, causing the temperature in fixing device 400 to decrease gradually. Similarly, the temperature in fixing device 400 is kept at the color target temperature during the fixing for jobs 3 and 5, whereas the temperature in fixing device 400 is kept at or above the monochrome target temperature during the fixing for job 4, which is a monochrome print job. After the fixing for job 5 is finished, the application of voltage to heater 405 is stopped to stop the heating of fixing device 400.

After the stop of heating of fixing device 400, residual heat remains in fixing device 400, which is not used even though it could enable printing. Moreover, there is an overshoot immediately after the stop of heating of fixing device 400, causing the temperature in fixing device 400 to be temporarily higher than the color target temperature. The quantity of residual heat emitted while the temperature in fixing device 400 is kept at or above the color target temperature is represented by the color print-enabling quantity of heat Nc. An overshoot is caused by a time lag during which heat is transmitted from heater 405 to the surface of heating roller 401 and by the fact that fan 407 for dissipating heat is stopped when the heating of fixing device 400 is stopped, which causes heat to be accumulated in fixing device 400 for some time. It should be noted that the quantity of heat generated from an overshoot can be increased by stopping fan 407 when the heating of fixing device 400 is stopped.

After the overshoot, the temperature in fixing device 400 decreases as the time passes; still, the temperature in fixing device 400 remains higher than the monochrome target temperature for a considerable period of time. The quantity of residual heat emitted while the temperature in fixing device 400 is kept at or above the monochrome target temperature, starting at the completion of job 5, is represented by monochrome print-enabling quantity of heat Nk.

On the contrary, an image forming device according to the present embodiment is an image forming device that receives a plurality of print jobs to form an image, including a toner image forming unit 300 (an example of an image forming unit) that forms a toner image on a manuscript (i.e. a recording medium), a fixing device 400 (an example of a fixing unit) that fixes a toner image formed on the recording medium, and a control unit 40 (an example of a control unit) that controls the image forming operation. The control unit determines a job to be printed using residual heat after the application of voltage to heater 405 is stopped based on an attribute of a job waiting to be printed, and performs the determined job.

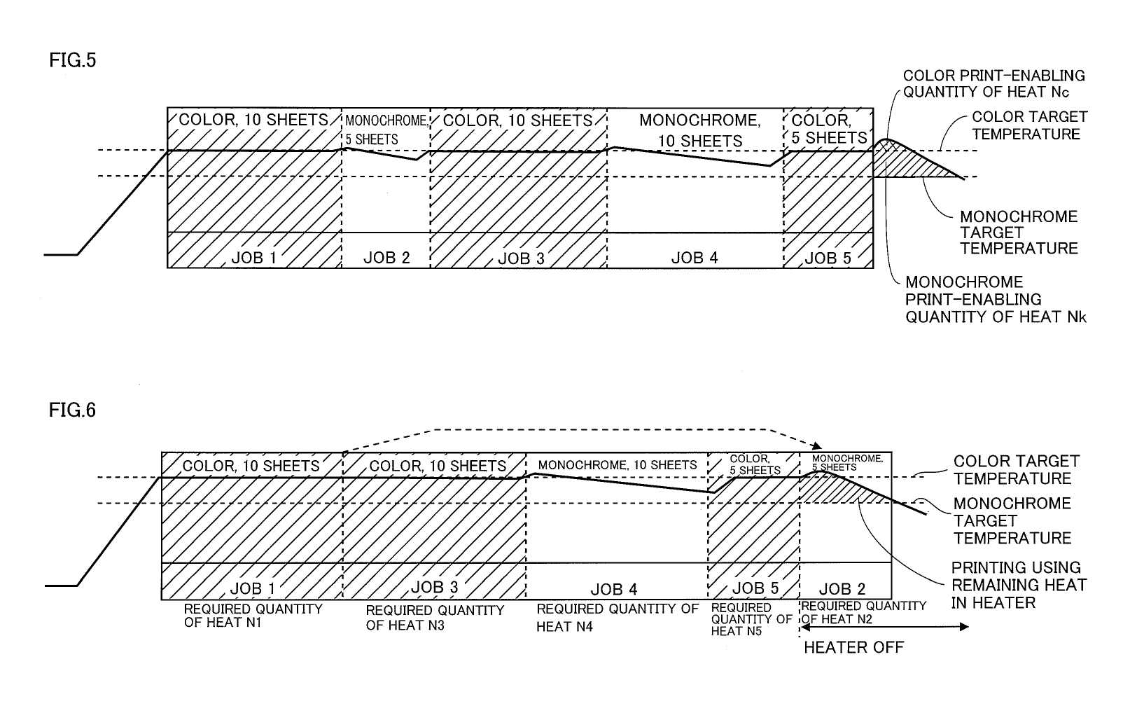

FIG. 6 schematically shows temperature changes in the fixing device in the image forming device of the first embodiment of the present invention. The vertical axis shows the temperature, while the horizontal axis shows the passing of time.

Referring to FIG. 6, according to the present embodiment, the heating of fixing device 400 is stopped after the fixing for job 5 is finished. Then, following job 5, the fixing (or printing) for job 2 is performed using residual heat in fixing device 400 (i.e. remaining heat from the heater) with heater 405 being off.

Thus, a job that can be printed using a quantity of heat remaining in fixing device 400 is selected from the stored jobs and then the jobs to be performed are reordered, allowing that selected job to be printed with the fixing heater being off, such that heat remaining in the fixing device when a print job is finished can be utilized to print a stored job. In the course of the processing of a plurality of print jobs, heat remaining in fixing device 400 when a job is finished (i.e. residual heat) that would otherwise be wasted can be used for printing to reduce power consumption in the printing of a plurality of jobs.

### Second Embodiment

The process in the image forming device according to the second embodiment of the present invention is different from that in the image forming device of the first embodiment in that a plurality of jobs can be printed using residual heat. The hardware configuration and the like of the image forming device according to the present embodiment are the same as those for the first embodiment and will not be described again. How the order of fixing is determined in the image forming device of the present embodiment will be described below together with a flow chart of a process for reordering fixing.

### [How Order of Fixing is Determined]

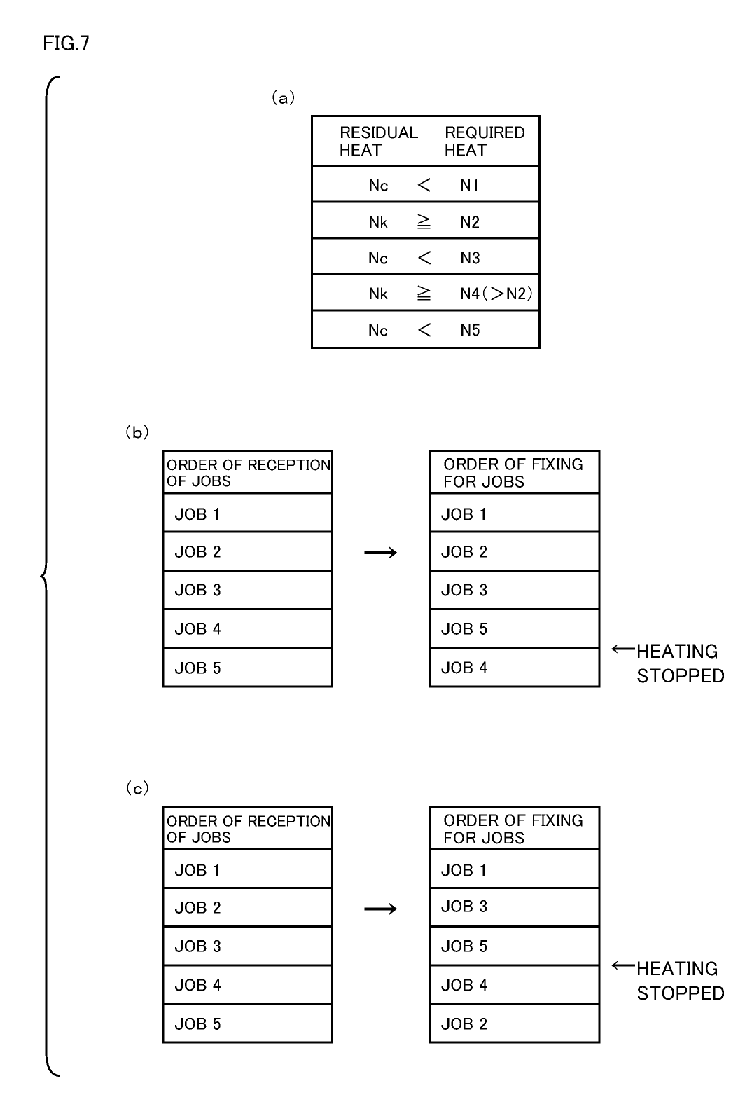

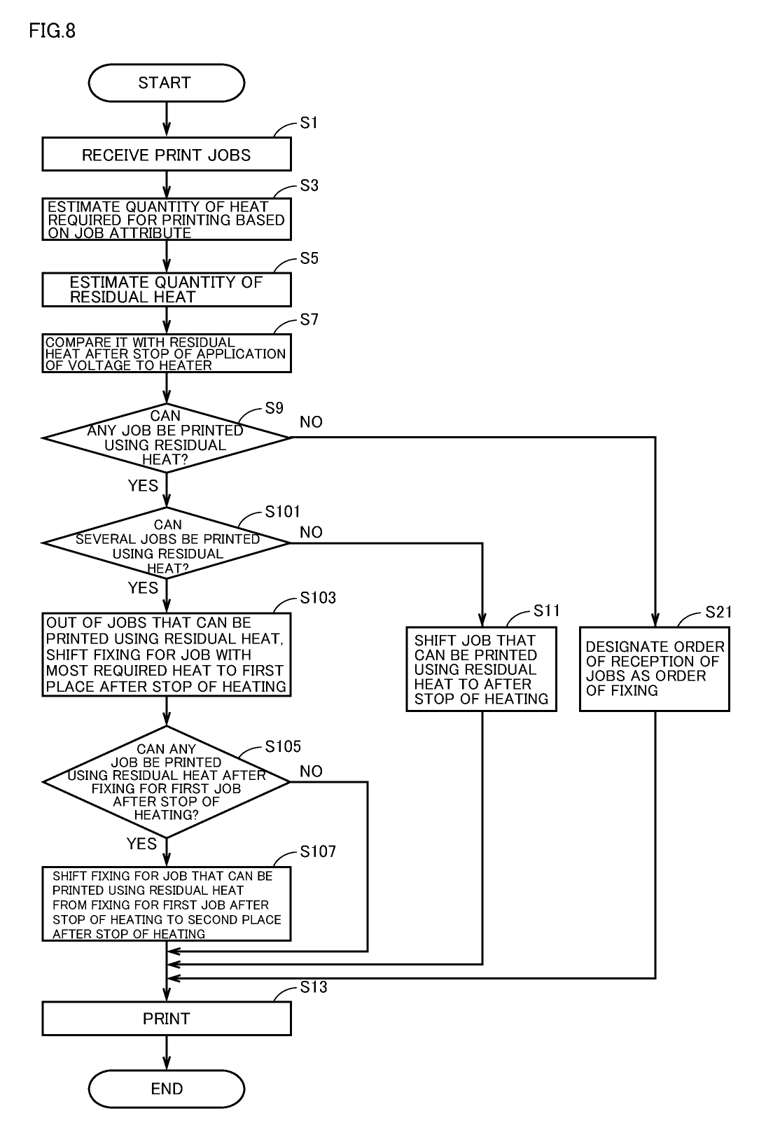

FIG. 7 illustrates another example of a change in the order of fixing for jobs 1-5. (a) is another example of a set of comparisons between the quantities of heat required for jobs 1-5 in FIG. 3(a) and the quantities of residual heat; (b) is another example of an order of fixing for jobs 1-5; and (c) is still another example of an order of fixing for jobs 1-5.

Referring to FIG. 7(a), similar to the first embodiment, it is assumed that CPU 41 received jobs 1-5 in this order from image reading unit 100 or a PC 102. Quantity of heat N1 for job 1, quantity of heat N3 for job 3 and quantity of heat N5 for job 5 are larger than color print-enabling quantity of heat Nc. Conversely, quantity of heat N2 for job 2 and quantity of heat N4 for job 4 are both equal to or smaller than monochrome print-enabling quantity of heat Nk. Quantity of heat N4 for job 4 is larger than quantity of heat N2 for job 2.

In this case, the fixing for job 2 or job 4 can be performed using residual heat after the stop of heating of fixing device 400. Meanwhile, quantity of heat N4 for job 4 is larger than quantity of heat N2 for job 2, and thus residual heat in fixing device 400 can be used more effectively for the fixing for a job if the fixing for job 4, rather than job 2, is performed immediately after the stop of heating of fixing device 400. Accordingly, CPU 41 designates job 4 as a post-heating job and changes job 4's turn for fixing.

As a result, as shown in FIG. 7 (b), the fixing for the jobs is reordered from the order of reception: job 1, job 2, job 3, job 4, and job 5 to the order: job 1, job 2, job 3, job 5, and job 4. Then, fixing device 400 is controlled such that the heating of fixing device 400 is stopped after the fixing for job 5 is finished and fixing is performed for job 4 using residual heat in fixing device 400 after the stop of heating.

Further, if the fixing for job 4 is performed immediately after the stop of heating of fixing device 400 and if quantity of heat N2 for job 2 is smaller than the quantity of residual heat estimated to be existing in fixing device 400 after the fixing for job 4, the fixing for job 2 may be performed after the fixing for job 4. The quantity of residual heat existing in fixing device 400 after the fixing for job 4 may be estimated to be quantity of heat N4 required for the fixing for job 4 subtracted from the quantity of residual heat immediately after the stop of heating of fixing device 400. In this case, CPU 41 shifts the fixing for job 2 to after the fixing for job 4.

Specifically, as shown in FIG. 7 (c), CPU 41 reorders the fixing for the jobs from the order of reception: job 1, job 2, job 3, job 4, and job 5 to the order: job 1, job 3, job 5, job 4, and job 2. Then, the heating of fixing device 400 is stopped after the fixing for job 5 is finished and fixing is performed for job 4 and then job 2 using residual heat in fixing device 400 after the stop of heating.

### [Flow Chart for Reordering Fixing]

Next, a process will be described for reordering the fixing for jobs when the control unit of the image forming device of the present embodiment has received a plurality of jobs. The process shown in the following flow chart is implemented by CPU 41 of control unit 40 performing a program.

FIG. 8 is a flow chart illustrating a process for reordering the fixing for jobs performed by a control unit of an image forming device according to the second embodiment of the present invention.

Referring to FIG. 8, CPU 41 begins with a process similar to that of S1-S9 shown in FIG. 4. Next, if the plurality of received jobs include a job that can be printed using residual heat (YES at S9), CPU 41 determines whether there are several jobs that can be printed using residual heat (S101). If there are several jobs that can be printed using residual heat (YES at S101), CPU 41 designates, out of the jobs that can be printed using residual heat, the job with the largest required quantity of heat as a post-heating job, and shifts the fixing for this post-heating job to immediately after the stop of heating of fixing device 400 (as the first one after the stop of heating) (S103). CPU 41 then determines whether the jobs that can be printed using residual heat include a job that can be printed using residual heat after the fixing for the post-heating job (S105). If there is a job that can be printed using residual heat after the fixing for the post-heating job (YES at S105), CPU 41 shifts the fixing for this job to after the fixing for the post-heating job (as the second one after the stop of heating) (S107). Thereafter, fixing device 400 is controlled such that printing is performed in the determined fixing order (S13), and the process ends.

If, at step S9, the received jobs include no job that can be printed using residual heat (NO at S9), CPU 41 does not reorder the fixing for the jobs and designates the order of reception of jobs as an order of fixing (S21). Fixing device 400 is then controlled such that printing is performed in the determined fixing order (S13), and the process ends.

If, at step S101, there is only one job that can be printed using residual heat (NO at S101), CPU 41 designates the job that can be printed using residual heat as a post-heating job and reorders the fixing for jobs, starting from the order of reception of jobs, such that the fixing for the post-heating job is performed after the stop of heating of fixing device 400 (S11). Fixing device 400 is then controlled such that printing is performed in the determined fixing order (S13), and the process ends.

If, at step S105, there is no job that can be printed using residual heat after the fixing for the post-heating job (NO at S105), fixing device 400 is controlled such that printing is performed in the order of fixing with only the post-heating job shifted (S13), and the process ends. These steps perform the process for reordering fixing.

It should be noted that, if there is yet another job that can be printed using residual heat existing in fixing device 400 after the fixing for the job that is the second in the fixing order after the stop of heating, fixing may be performed for that job following the job that is the second in the fixing order after the stop of heating.

### [Effects of Present Embodiment]

If there are several jobs with required quantities of heat smaller than the estimated quantity of residual heat (i.e. quantity of remaining heat) existing in the fixing unit after the fixing for a post-heating job (i.e. a job that can be printed using a quantity of residual heat), the image processing device of the present embodiment determines a post-heating job such that a job with a larger required quantity of heat is printed using a quantity of residual heat, and reorders the jobs. Further, fixing is reordered such that the fixing for a job with a required quantity of heat smaller than the estimated quantity of residual heat existing in the fixing unit following the fixing for the post-heating job is performed after the fixing for the post-heating job. Thus, more residual heat generated in fixing device 400 can be used for fixing, thereby further reducing power consumption.

### Third Embodiment

The process in the image forming device according to the third embodiment of the present invention is different from that in the image forming device of the first embodiment in that fixing is performed for a color print job directly before the stop of heating of the fixing device. The hardware configuration and the like of the image forming device according to the present embodiment are the same as those for the first embodiment and will not be described again. How the order of fixing is determined in the image forming device of the present embodiment will be described below together with a flow chart of a process for controlling the heater of the fixing device.

### [How Order of Fixing is Determined]

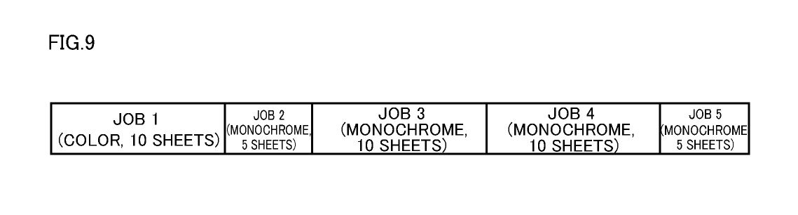

FIG. 9 illustrates an attribute of jobs 1-5.

Referring to FIG. 9, it is assumed that CPU 41 received jobs 1-5 in this order from image reading unit 100 or a PC 102. Job 1 includes a ten color prints; job 2 includes five monochrome prints; job 3 includes ten monochrome prints; job 4 includes ten monochrome prints; and job 5 includes five monochrome prints. Jobs 1-5 have the same attributes except for image color (color/monochrome) and number of sheets to be printed.

CPU 41 performs fixing for a color print job chosen from received jobs 1-5 directly before the stop of heating of fixing device 400. Since only job 1 is a color print job in FIG. 9, CPU 41 reorders the fixing for jobs such that the fixing for job 1 is performed directly before the stop of heating of fixing device 400. It should be noted that, if there are several color print jobs, fixing may be performed for the job with the largest required quantity of heat (or quantity of residual heat generated) directly before the stop of heating of fixing device 400, or fixing may be performed for any one of the color print jobs directly before the stop of heating of fixing device 400.

Thereafter, the quantity of residual heat generated in fixing device 400 may be estimated based on an attribute of job 1.

### [Flow Chart for Reordering Fixing]

Next, a process will be described for reordering the fixing for jobs when the control unit of the image forming device of the present embodiment has received a plurality of jobs. The process shown in the following flow chart is implemented by CPU 41 of control unit 40 performing a program.

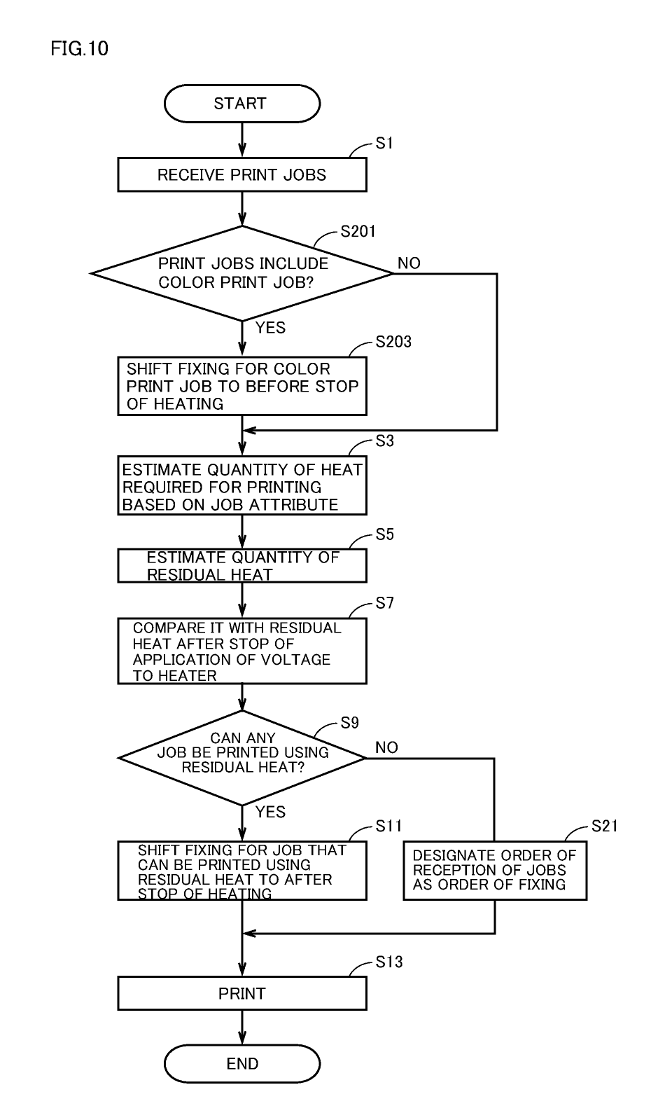

FIG. 10 is a flow chart illustrating a process for reordering the fixing for jobs performed by a control unit of an image forming device according to the second embodiment of the present invention.

Referring to FIG. 10, CPU 41 receives job input from image reading unit 100 or a PC 102 for a predetermined period of time, for example, to acquire image information about a plurality of jobs (S1). When CPU 41 receives the jobs, it determines whether the received jobs include a color print job (S201). If a color print job is included (YES at S201), CPU 41 reorders fixing such that the fixing for that color print job is performed directly before the stop of heating of fixing device 400 (S203). Then, CPU 41 performs a process similar to that following S3 shown in FIG. 4. Conversely, if there is no color print job (NO at S201), CPU 41 performs a process similar to that following S3 shown in FIG. 4 without undergoing S203. These steps perform a process for reordering fixing.

### [Effects of Present Embodiment]

Generally, color target temperatures are higher than monochrome target temperatures because monochrome printing only requires the fixing of black toner, while color printing requires the fixing of toner of four colors, i.e. black, cyan, magenta and yellow. Therefore, there is more residual heat in fixing device 400 immediately after a color print job than there is in fixing device 400 immediately after a monochrome print job. Accordingly, performing the fixing for a color print job directly before the stop of heating of fixing device 400 results in more residual heat in fixing device 400 after the stop of heating, which may be used to perform the fixing for a job with a larger required quantity of heat. As a result, power consumption can be further reduced.

### Fourth Embodiment

The process in the image forming device according to the fourth embodiment of the present invention is performed when the image forming device, with several received jobs being not yet printed, receives a new job.

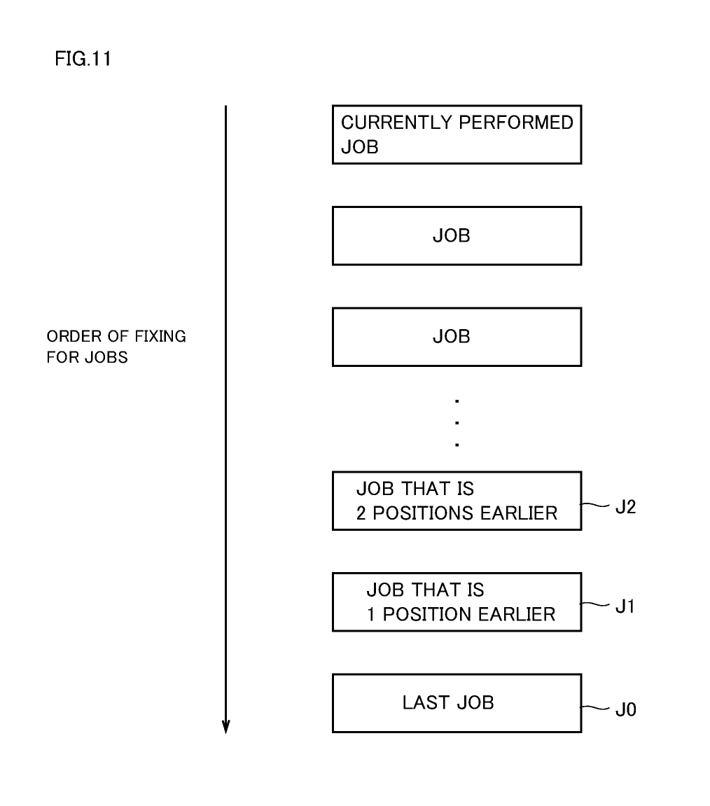

FIG. 11 illustrates a fixing order of a plurality of unprinted jobs.

Referring to FIG. 11, several unprinted jobs are arranged in the order of fixing from top to bottom in the drawing. The job position located two positions before the last one in the order of fixing for jobs is referred to as job position J2; the job position located one position before the last one is referred to as job position J1; and the last job position is referred to as job position J0.

Generally, the quantity of residual heat in fixing device 400 immediately after a color print job is larger than that in fixing device 400 immediately after a monochrome print job, and the required quantity of heat for a monochrome job is smaller than that for a color print job. If the received jobs include a color print job and a monochrome print job and if an attribute of the monochrome print job is equal to or smaller than a reference value, a new order of fixing for jobs is determined such that the color print job is placed in job position J1 and the monochrome print with a job attribute equal to or smaller than the reference value is placed in job position J0, and the heating of fixing device 400 is stopped immediately after the fixing for the job in job position J1. By determining a new order of fixing for jobs in this way, residual heat generated by the fixing for the color print job in job position J1 can be used for the fixing for the monochrome print job in job position J0.

Now, a process will be described for reordering fixing and for controlling the heater in the fixing device when the image forming device, with several received jobs being not yet printed, receives a new job.

### [Flow Chart of Process for Reordering Fixing]

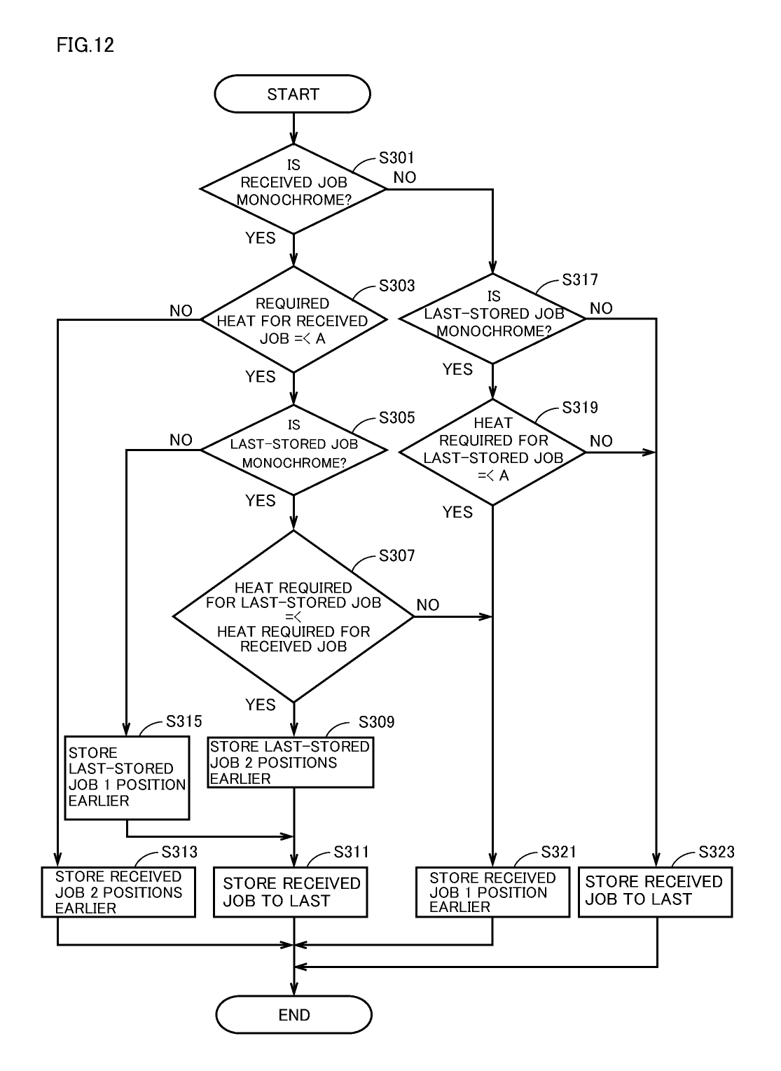

FIG. 12 is a flow chart illustrating a process for reordering the fixing for jobs performed by a control unit of an image forming device according to the fourth embodiment of the present invention. The process shown in the following flow chart is implemented by CPU 41 of control unit 40 performing a program.

Referring to FIG. 12, CPU 41 determines whether the newly received job is a monochrome print job (S301). If the newly received job is a monochrome print job (YES at S301), CPU 41 determines whether the required quantity of heat for the newly received job is equal to or smaller than reference A (S303).

Reference A may be, for example, the quantity of residual heat estimated to exist in fixing device 400 immediately after the fixing for a color print job. Further, instead of the determining method described above, it may be determined whether an attribute of the newly received job (for example, the amount of data) is equal to or smaller than a reference (i.e. reference amount) A.

If the required quantity of heat for the newly received job is equal to or smaller than reference A, it is determined that fixing can be performed for the newly received job using residual heat from the fixing for a color print job (YES at S303). In this case, CPU 41 determines whether the job stored at the end (i.e. the job in job position J0) is a monochrome print job (S305). If the job in job position J0 is a monochrome print job (YES at S305), it is determined whether the newly received job should be designated as a post-heating job by determining whether the required quantity of heat for the newly received job is equal to or larger than the required quantity of heat for the job in job position J0 (S307). If the required quantity of heat for the newly received job is equal to or larger than the required quantity of heat for the job in job position J0 (YES at S307), the newly received job replaces the job that is now in job position J0 as a post-heating job. In this case, CPU 41 stores the job that is now in job position J0 two positions earlier (i.e. shifts it to job position J2) (S309), stores the newly received job to the end (i.e. places it in job position J0) (S311), and the process ends.

If, at step S303, the required quantity of heat for the newly received job is larger than reference A, it is determined that fixing cannot be performed for the newly received job using residual heat from the fixing for the color print job (NO at S303). In this case, CPU 41 stores the newly received job two positions earlier (i.e. places it in job position J2) (S313), and the process ends.

If, at step S305, the job in job position J0 is a color print job (NO at S305), the newly received job is designated as a post-heating job. In this case, CPU 41 stores the job that is now in job position J0 one position earlier (i.e. shifts it to job position J1) (S315) and stores the newly received job to the end (i.e. places it in job position J0) (S311), and the process ends.

If, at step S307, the required quantity of heat for the newly received job is smaller than the required quantity of heat for the job in job position J0 (NO at S307), the newly received job is not designated a post-heating job. In this case, CPU 41 stores the newly received job one position earlier (i.e. places it in job position J1) (S321), and the process ends.

If, at step S301, the newly received job is a color print job (NO at S301), CPU 41 determines whether the job in job position J0 is a monochrome print job (S317). If the job in job position J0 is a monochrome print job (YES at S317), CPU 41 determines whether the required quantity of heat for the job in job position J0 is equal to or smaller than reference A (S319).

Reference A may be the quantity of residual heat estimated to exist in fixing device 400 immediately after the fixing for a color print job, for example. Further, instead of the determining method described above, it may be determined whether an attribute of the job in job position J0 (for example, the amount of data) is equal to or smaller than a reference (i.e. a reference amount) A.

If the required quantity of heat for the job in job position J0 is equal to or smaller than reference A, it is determined that fixing can be performed for the job in job position J0 using residual heat from the fixing for the newly received color print job (YES at S319). In this case, CPU 41 stores the newly received job one position earlier (i.e. places it in job position J1) (S321), and the process ends.

If, at step S317, the job in job position J0 is a color print job (NO at S317), or if, at step S319, the required quantity of heat for the job in job position J0 is larger than reference A (NO at S319), CPU 41 stores the newly received job to the end (i.e. places it in job position J0) (S323), and the process ends.

### [Flow Chart of Process for Controlling Heater in Fixing Device]

Next, in connection with the jobs whose fixing order was determined by the above method, a process will be described for controlling heater 405 in the fixing device while fixing is performed for the jobs.

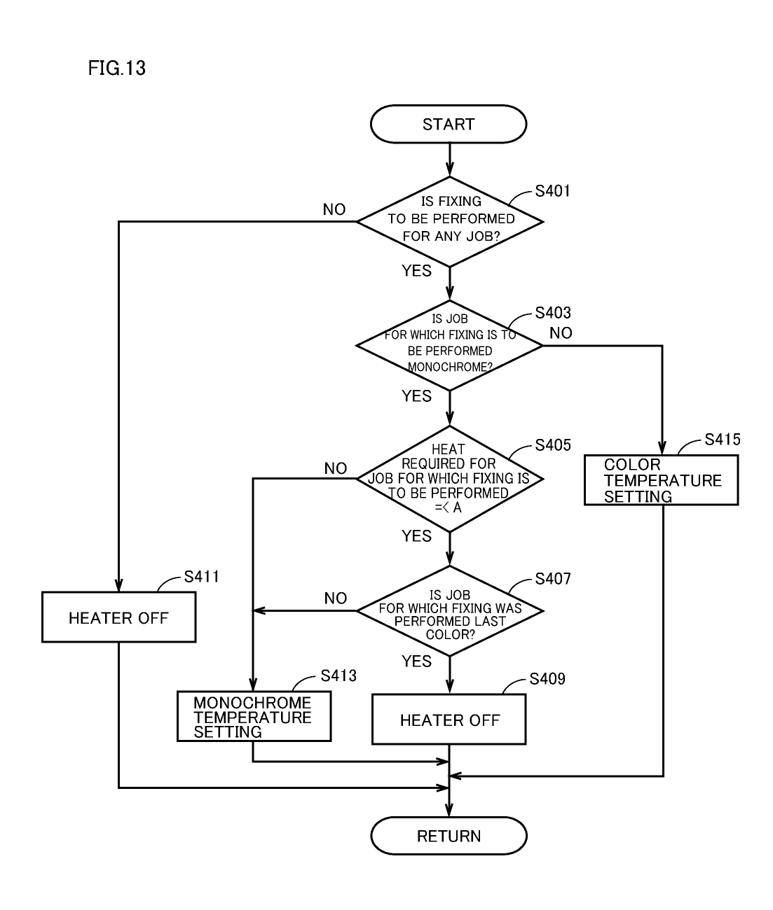

FIG. 13 is a flow chart illustrating a process for controlling a heater performed by the control unit of the image forming device according to the fourth embodiment of the present invention.

Referring to FIG. 13, if there is a job for which fixing is to be performed (i.e. the first job in the fixing order (i.e. the fixing for it is performed the earliest)), (YES at S401), CPU 41 determines whether that job is monochrome (S403). If there is no job for which fixing is to be performed (NO at S401), CPU 41 turns off heater 405 of fixing device 400 (S411).

At S403, if the job for which fixing is to be performed is a monochrome job (YES at S403), CPU 41 determines whether the required quantity of heat for that job is equal to or smaller than reference A (S405).

Reference A may be, for example, the quantity of residual heat estimated to exist in fixing device 400 immediately after the fixing for a color print job. Further, at S405, instead of the determining method described above, it may be determined whether an attribute of the job for which fixing is to be performed (for example, the amount of data) is equal to or smaller than a reference (i.e. a reference amount) A.

If the required quantity of heat for the job for which fixing is to be performed is equal to or smaller than reference A, it is determined that the fixing for that job can be performed using residual heat from the fixing for a color print job (YES at S405). In this case, CPU 41 determines whether the job for which fixing was performed last (i.e. immediately before it) was a color print job (S407). If the job for which fixing was performed last was a color print job (YES at S407), the fixing for the job for which fixing is to be performed can be performed using residual heat generated in fixing device 400 by the fixing for the last job. In this case, the fixing for the job for which fixing is to be performed is performed with heater 405 being off (S409), and the process returns.

At S403, if the job for which fixing is to be performed is a color print job (NO at S403), fixing device 400 is set to the color target temperature and the fixing for that job is performed (S415), and the process returns.

If, at S405, the required quantity of heat for the job for which fixing is to be performed is larger than reference A (NO at S405), or if, at S407, the job for which fixing was performed last was a monochrome print job (NO at S407), it is determined that the fixing for the job for which fixing is to be performed cannot be performed using residual heat generated in fixing device 400. In such a case, fixing device 400 is set to the monochrome target temperature and the fixing for the job for which fixing is to be performed is performed (S413), and the process returns. The steps in FIG. 13 are repeated at predetermined timings. These steps perform the process for controlling heater 405 of fixing device 405.

It should be noted that the hardware configuration and the like of the image forming device according to the present embodiment are the same as those for the first embodiment and will not be described again.

### [Effects of Present Embodiment]

In the present embodiment, if CPU 41 receives a color print job and a monochrome print job and if an attribute of the monochrome print job is equal to or smaller than reference A, CPU 41 controls fixing device 400 such that the heating of fixing device 400 is stopped immediately after the fixing for the color print job and the fixing for the monochrome print job is performed after the stop of heating of fixing 400. In this way, even when the image forming device, with several received jobs being not yet printed, receives another job, fixing can be reordered to enable the use of residual heat from the color print job for the fixing for the monochrome print job.

### Fifth Embodiment

While the first embodiment described an image processing device incorporated in an image forming device, an image processing device of the present invention may be separated from an image forming device, in which case fixing may be reordered at any one of a plurality of image forming devices connected to an image processing device. A configuration of such an image forming system including an image processing device according to the present embodiment and a process performed by the image processing device will be described below.

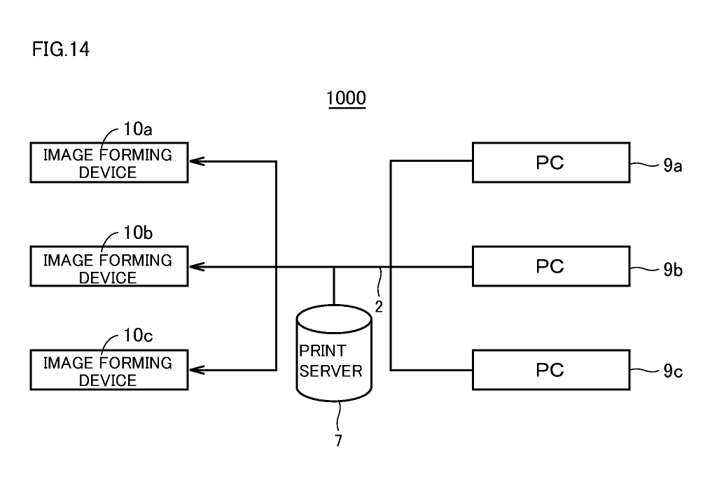

FIG. 14 shows an entire configuration of an image forming device system according to a fifth embodiment of the present invention. Referring to FIG. 14, an image forming device system 1000 according to the present embodiment includes: PCs 9a, 9b and 9c connected to a network 2; image forming devices 10a, 10b and 10c; and a print server 7 that serves as an image processing device. PCs 9a, 9b and 9c have a similar hardware configuration; any one of them will be referred to as a “PC 9”. Image forming devices 10a, 10b and 10c have a similar configuration for an image forming device; any one of them will be referred to as an “image forming device 10”.

Network 2 is a wired or wireless local area network (LAN). Connection within Network 2 is established using the Transmission Control Protocol/Internet Protocol (TCP/IP). Devices connected to network 2 are capable of exchanging various data with one another. Network 2 may be replaced by a wide area network, such as the Internet or a private line, to connect the devices.

PC 9 is a personal computer that includes: a PC body having a CPU, random access memory (RAM), read only memory (ROM), electrically erasable and programmable read only memory (EEPROM), a hard disk drive (HDD) and other components; a monitor; and an input device such as a key board and a mouse. PC 9 includes, in its storage device, application software used to create documents and drawings. PC 9 instructs image forming device 10 to print a created document or the like.

Print server 7 may have a configuration similar to control unit 40 in the first embodiment shown in FIG. 1, for example. Print server 7 may be a personal computer including a PC body having a CPU, RAM, ROM, EEPROM, a hard disk drive (HDD) and other components, a monitor, and an input device such as a key board and a mouse.

For example, print server 7 receives from PCs 9a-9c a plurality of jobs (jobs 1-5) related to image forming. Next, print server 7 allocates each of jobs 1-5 to one of image forming devices 10a-10c. At the time of the allocating of jobs, if there is an image forming device (for example, image forming device 10b) capable of performing the fixing for a particular job (for example, job 1) using residual heat in its fixing device, print server 7 reorders jobs 1-5 based on an attribute of jobs 1-5 such that the fixing for job 1 is performed after the stop of heating of the fixing device of image forming device 10b. Print server 7 then controls the fixing device of each of image forming devices 10a-10c such that fixing is performed for the allocated jobs in the resulting order of fixing.

It should be noted that the specific configuration of image forming device 10 and the method of controlling an image processing device other than what was described above are generally the same as those for the first embodiment and will not be described again.

An image processing device of the present embodiment can reduce power consumption at image forming device 10 and image forming device system 1000.

### [Others]

While the above embodiments showed that a post-heating job can be determined based on a required quantity of heat and a quantity of residual heat, the present invention is not limited thereto and encompasses all variations where at least one job out of a plurality of jobs is determined for which fixing can be performed after the heating of the fixing unit is stopped and for which fixing is performed after the fixing for another job is finished. For example, if fixing is performed for a color print job directly before the stop of heating of fixing device 400, a job including a number equal to or smaller than a predetermined number of monochrome prints may be designated as a job for which fixing can be performed after the heating of the fixing unit is stopped and for which fixing is performed after the fixing for that color print job is finished. Alternatively, a job for which fixing can be performed after the stop of heating of fixing device 400 can be determined based on the number of prints in a color print job for which fixing is performed directly before the stop of heating of fixing device 400.

While the above embodiments provided that the color target temperature is higher than the monochrome target temperature, any relation can be established between the color target temperature and the monochrome target temperature and the present invention is not limited to the above provision.

Any of the above embodiments may be combined with any other one(s). For example, in the fourth embodiment, fixing may be performed for a plurality of jobs after the stop of heating, as in the second embodiment.

The processes in the above embodiments may be performed by software or hardware circuitry.

Alternatively, a program for executing the processes of the above embodiments may be provided, or a CD-ROM, a flexible disk, a hard disk, a ROM, a RAM, a memory card or other storage media storing that program may be provided for the user. The program is executed by a computer such as a CPU. Further, the program may be transmitted via the Internet or other communication lines and downloaded to a device.

An image processing device and a method of controlling an image processing device of the above embodiments can reduce power consumption.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing device for processing jobs to be executed by an image forming device including a fixing unit, comprising:
a receiving unit that receives a plurality of jobs;
a determining unit that, based on an attribute of each of the plurality of jobs, determines, out of the plurality of jobs, at least one job for which fixing can be performed after heating of the fixing unit is stopped and for which fixing is performed after fixing for another job is finished; and
a reordering unit that reorders processing of the plurality of jobs so that fixing is performed for the at least one job determined by the determining unit after the fixing for the other job is finished and after the heating of the fixing unit is stopped.

2. The image processing device according to claim 1, wherein the determining unit estimates a quantity of heat required for fixing for each of the plurality of jobs to determine the at least one job based on the quantity of heat required for fixing.

3. The image processing device according to claim 2, wherein the determining unit estimates a quantity of residual heat existing in the fixing unit after the heating is stopped to determine the at least one job based on the quantity of residual heat.

4. The image processing device according to claim 3, wherein the determining unit determines, as the at least one job, a job with a quantity of heat required for fixing smaller than the quantity of residual heat.

5. The image processing device according to claim 4, wherein, if there are several jobs with a quantity of heat required for fixing smaller than the quantity of residual heat, the determining unit determines, as the at least one job, a job with the largest quantity of heat required for fixing out of the several jobs with a quantity of heat required for fixing smaller than the quantity of residual heat.

6. The image processing device according to claim 2, wherein the reordering unit reorders the processing of the plurality of jobs such that fixing for the job with a quantity of heat required for fixing smaller than the estimated quantity of residual heat generated in the fixing unit after the fixing for the at least one job is performed after the fixing for the at least one job.

7. The image processing device according to claim 1, wherein the determining unit estimates a quantity of residual heat existing in the fixing unit after the heating is stopped to determine the at least one job based on the quantity of residual heat.

8. The image processing device according to claim 1, wherein, if the plurality of jobs include a color print job, the reordering unit reorders fixing such that fixing for the color print job is performed directly before the stop of heating of the fixing unit.

9. The image processing device according to claim 1, wherein if the plurality of jobs include a color print job and a monochrome print job and if an attribute of the monochrome print job is equal to or smaller than a reference value, the determining unit determines the monochrome print job as the at least one job and the reordering unit reorders processing of the plurality of jobs such that fixing is performed for the color print job directly before the stop of heating of the fixing unit.

10. A method of controlling an image processing device for processing jobs to be executed by an image forming device including a fixing unit, comprising the steps of:
receiving a plurality of jobs;
determining, based on an attribute of each of the plurality of jobs, out of the plurality of jobs, at least one job for which fixing can be performed after heating of the fixing unit is stopped and for which fixing is performed after fixing for another job is finished; and
reordering processing of the plurality of jobs so that fixing is performed for the at least one job determined by the determining unit after the fixing for the other job is finished and after the heating of the fixing unit is stopped.

11. The method of controlling an image processing device according to claim 10, wherein the determining step estimates a quantity of heat required for fixing for each of the plurality of jobs to determine the at least one job based on the quantity of heat required for fixing.

12. The method of controlling an image processing device according to claim 11, wherein the determining step estimates a quantity of residual heat existing in the fixing unit after the heating is stopped to determine the at least one job based on the quantity of residual heat.

13. The method of controlling an image processing device according to claim 12, wherein the determining step determines, as the at least one job, a job with a quantity of heat required for fixing smaller than the quantity of residual heat.

14. The method of controlling an image processing device according to claim 13, wherein, if there are several jobs with a quantity of heat required for fixing smaller than the quantity of residual heat, the determining step determines, as the at least one job, a job with the largest quantity of heat required for fixing out of the several jobs with a quantity of heat required for fixing smaller than the quantity of residual heat.

15. A control program for an image processing device for processing jobs to be executed by an image forming device including a fixing unit, stored in a computer readable medium to cause a computer to execute processing comprising the steps of:
receiving a plurality of jobs;
determining, based on an attribute of each of the plurality of jobs, out of the plurality of jobs, at least one job for which fixing can be performed after heating of the fixing unit is stopped and for which fixing is performed after fixing for another job is finished; and
reordering processing of the plurality of jobs so that fixing is performed for the at least one job determined by the determining unit after the fixing for the other job is finished and after the heating of the fixing unit is stopped.

16. The control program for an image processing device according to claim 15, wherein the determining step estimates a quantity of heat required for fixing for each of the plurality of jobs to determine the at least one job based on the quantity of heat required for fixing.

17. The control program for an image processing device according to claim 16, wherein the determining step estimates a quantity of residual heat existing in the fixing unit after the heating is stopped to determine the at least one job based on the quantity of residual heat.

18. The control program for an image processing device according to claim 17, wherein the determining step determines, as the at least one job, a job with a quantity of heat required for fixing smaller than the quantity of residual heat.

19. The control program for an image processing device according to claim 18, wherein, if there are several jobs with a quantity of heat required for fixing smaller than the quantity of residual heat, the determining step determines, as the at least one job, a job with the largest quantity of heat required for fixing out of the several jobs with a quantity of heat required for fixing smaller than the quantity of residual heat.
